(19) United States
(12) Patent Application Publication
(10) Pub. No.: US 2008/0255237 A1
(43) Pub. Date: Oct. 16, 2008

(54) Pesticidal Composition

(75) Inventors: Thomas McGee, Nyack, NY (US); Rodrigo Rodriguez-Kabana, Auburn, AL (US); Richard P. Sgaramella, Hoboken, NJ (US)

Correspondence Address: NORRIS, MCLAUGHLIN & MARCUS, 875 THIRD AVE, 18TH FLOOR, NEW YORK, NY, 10022, US

(73) Assignee: GIVAUDAN SA, Vernier (CH)

(21) Appl. No.: 12/089,945

(22) PCT Filed: Oct. 9, 2006
(86) PCT No.: PCT/CH2006/000556

§ 371 Date: Jun. 24, 2008

Related U.S. Application Data
(60) Provisional application No. 60/726,816, filed on Oct. 14, 2005.

(51) Int. Cl. A01N 37/00; A01P 15/00

(52) U.S. Cl. 514/574

(57) ABSTRACT

A pesticidal preparation comprises a pesticidal composition consisting essentially of a mixture of garlic oil and allyl isothiocyanates (AITCs) in the weight ratio of from 95:5 to 60:40. It is especially effective as a pesticide, especially against nematodes commonly found in the soil.

This invention relates to the field of pest control, and, in particular, it relates to compositions and methods useful for controlling pests, especially soil-based pests.

A variety of plant pests are known to cause significant damage to seeds and ornamental and crop plants. Pests include worms, insects, nematodes, slugs, fungi, and the like. Generally these pests are controlled by chemical pesticides, most of which are toxic to humans or animals and/or the environment and which may persist long after they are applied.

The United States Federal Insecticide, Fungicide and Rodent Act (FIFRA) defines a “pesticide” as any substance or mixture of substances intended for preventing, destroying, repelling, or mitigating any pest. Because of concerns regarding the toxicity of chemical pesticides the Environmental Protection Agency (EPA) exempted certain minimum risk pesticides from the FIFRA. The actives in the list include several essential oils such as citronella oil, clove oil, geranium oil, mint oil, peppermint oil, lemon grass oil, garlic oil, thyme oil, cedar oil and cinnamon oil.

Essential oils have been used since ancient times as pesticides. Many publications show the fungicidal properties of essential oils and several patents have claimed them for controlling a variety of pests. For example garlic is sold under several brand names; many contain only low level of garlic oil, which limits their effectiveness. U.S. Pat. No. 6,511,674 teaches better efficacy if the composition a garlic extract solution having a quantifiable concentration of greater than ten percent by weight of a garlic extract, the garlic extract comprising allitin, allicin, diallyl disulfide, and dimethyl sulfoxide.

Another route is to use the Cruciferae family of plants, whose members contain glucosinolates and myrosinase enzymes, which upon destruction form allyl isothiocyanates (AITCs) and other compounds which are harmful to pests, such as nematodes, pathogenic fungi, and which produce a pungent bitter taste for chewing predators. For example U.S. Pat. No. 6,207,705 teaches the use of natural and closely-related synthetic derivatives or analogs related to two classes of natural compounds, namely glucosinolates and monoterpenoids. A particularly good source of AITCs is mustard oil.

However, the use of these natural pesticides as replacements for chemical pesticides has not been as successful as anticipated, probably due to lower efficacy. Attempts have been made to enhance their efficacy, for example, U.S. Pat. No. 6,231,865 claims a natural insecticide for inhibiting the growth of insects, the insecticide comprising garlic extract and an oil selected from the group consisting of cotton seed oil, and cinnamon oil.

Recently, the US Federal Government started offering a “fast-track” registration process with the EPA for “biopesticides”, which include both naturally-based pesticides and close derivatives or analogs.

One of the problems of using natural pesticides such as essential oils is that they are highly volatile and their activity is only for a short duration. One way of having sustained release is to encapsulate using technologies such as those outlined in US patent application 2005-0214337.

It has now been discovered that, if garlic and AITCs are used together in particular ratios, there is a surprising and unexpected improvement in performance, particularly in strength and duration of effect. The invention, in one aspect, therefore provides a pesticidal composition consisting essentially of a mixture of garlic oil and AITCs in the weight ratio of from 95:5 to 60:40.

In a further aspect the present invention provides a pesticidal preparation comprising a pesticidal composition consisting essentially of a mixture of garlic oil and allyl isothiocyanates (AITCs) in the weight ratio of from 95:5 to 60:40, and optionally one or more further constituents, e.g., carriers.

The invention additionally provides a method of controlling plant pests, comprising the application to the plant and/or to the soil in which it is growing a composition that consists essentially of a mixture of garlic oil and AITCs in the weight ratio of from 95:5 to 60:40.

The weight ratio is preferably between 90:10 and 70:30 and most preferably between 85:15 and 80:20.

Although pure AITCs may be used, it is preferable that a natural source be used. An especially good source is mustard seed oil.

Another preferred embodiment is where the garlic oil and AITC are incorporated into capsules that are biodegradable.

A most preferred embodiment is where the capsule has a hydrogel shell and an oily core, the garlic and AITC being loaded to blank capsules in the presence of water. Such capsules are described, for example, in U.S. Pat. Nos. 6,045,835 and 6,106,875, the contents whereof are incorporated herein by reference. Blank capsules of this type are available commercially from Givaudan Flavors Corp.

The composition of the invention may also be incorporated into other controlled release systems. Many of these are known in the art. Preferred would be particles that are spray dried or agglomerated using core materials on the EPA list of inerts, for example dextrose, sodium chloride and the like.

A preferred embodiment is where the synergistic composition is premixed into a high molecular weight, low melting point wax or solid that may be mixed readily with support material, the supporting material is a material capable of absorbing the essential oil and high molecular weight, low boiling point wax or solid to the extent that the resultant mixture is in the form of a free-flowing powder; and provides the means of controlling the release of the garlic and AITC mixture. Suitable solids are materials such as clays; silicas; celites; zeolites; metal salts, including for example, phosphates; carbonates, such as sodium bicarbonate; borates, such as sodium borate; sulfates such as sodium sulfate; water soluble polymers; borax; and mixtures thereof.

The composition can be utilized with any suitable carrier. The choice of carrier will depend upon the method of application. Liquid carriers such as water can be used so that it can be applied as sprays and the like. In the case of water, if required, a suitable emulsifier/solvent could be employed. Preferably an EPA approved material such as sodium lauryl sulphate is used. Other suitable liquids can be selected, preferably those on the EPA list of inerts, for example corn oil, linseed oil and soybean oil.

Solid carriers may be any inert materials such as ground corn cob, cellulose, sand, soil, ground rock, fly ash, and mixtures thereof.

The composition may be applied as part liquid and part carrier.

It is also envisaged that the composition may be formulated with other pesticides and/or essential oils to mitigate the odor of garlic.

The invention is further described with reference to the following examples, in which all parts, percentages and ratios are by weight.

### EXAMPLES

### Example 1

The following capsules were prepared and tested for release:

10% (wt.) garlic

10% (wt.) AITC (mustard oil)

10% (wt.) (90 garlic:10 AITC (w/w %))

### Procedure:

Garlic, AITC or a mixture of the two in the weight ratio of 90:10 were loaded as actives at 10% wt. loadings into gelatin microcapsules obtained from Givaudan Corporation, according to the procedure hereinunder described.
1. Mix active, alcohol and water (liquid phase) in the following proportions (all amounts in % wt.):

| | | AITC | |
|---|---|---|---|
| | Garlic | % | 90 Garlic/10 |
| | % (w/w) | (w/w) | AITC % (w/w) |
| Gelatin capsules | 75 | 75 | 75 |
| Active | 10 | 10 | 10 |
| Alcohol | 10 | 10 | 10 |
| Water | 5 | 5 | 5 |

2. Stir vigorously until an emulsion is formed.
3. Pour the liquid phase emulsion over the caps in a cement mixer and homogenize the mixture.
4. Leave it tumbling until the powder is dry and free flowing.

### Application

50 mgs were mixed into 1 kg of soil. These were placed into a glass jar. A headspace sample was taken each day and analysed. The following results were obtained:

| | NANOGRAMS PER LITER | | |
|---|---|---|---|
| | Garlic | Mustard | 90:10 (w/w) Garlic:AITC |
| Day 1 | 4692 | 3590 | 9283 |
| Day 7 | 918 | 713 | 7876 |
| Day 14 | 248 | 36 | 4456 |
| Day 23 | 105 | 2.6 | 1335 |
| Day 28 | 102 | 1.1 | 1004 |

Surprisingly the mixture is able to sustain a high level of actives released for longer than the single materials.

### Example 2

The following capsules were prepared as per example 1 (all amounts in % wt.):

| | Garlic | | | |
|---|---|---|---|---|
| | % | AITC | 85 Garlic/15 | 50 Garlic/50 |
| | (w/w) | % (w/w) | AITC % (w/w) | AITC % (w/w) |
| Gelatin capsules | 75 | 75 | 75 | 75 |
| Active | 10 | 10 | 10 | 10 |
| Alcohol | 10 | 10 | 10 | 10 |
| Water | 5 | 5 | 5 | 5 |

### Application

50 mgs were mixed into 1 kg of soil. These were placed into a glass jar. A headspace sample was taken each day and analysed. The following results were obtained:

| | NANOGRAMS PER LITER | |
|---|---|---|
| | 85:15 (wt/wt) Garlic:AITC | 50:50 (wt/wt) Garlic:AITC |
| Day 1 | 9877 | 4917 |
| Day 7 | 8006 | 3177 |
| Day 14 | 4683 | 1863 |

This indicates that the effect of the mixture will not be as long lasting if the ratio of garlic to AITC becomes too high.

### Example 3

This example investigates whether seeds could be protected against pests via prolonged pesticidal activity and be re-activated on planting by slow continued release of garlic and AITC.

The following capsules were made:

A mixture of garlic and AITC in the ratio of 90:10 (wt/wt) was loaded at 10% (wt) into gelatin microcapsules obtained from Givaudan Corporation, according to the procedure in example 1.

Corn Seeds were dyed red using Gustafson Pro-Ized seed colorant. A 10% aqueous solution was prepared and the seeds were mixed and tumbled with this solution. The seeds were allowed to air dry before addition of the garlic/AITC capsules.

Seeds were prepared by fixing various concentrations of capsules accordingly:
0.50% (5 g capsules/Kg seeds)
1.00% (10 g capsules/Kg seeds)

The seeds were analyzed by collecting headspace as follows:

The seeds were placed into 1 liter glass collection jars and allowed to equilibrate for 30 minutes before collection, this represents the dry conditions. For the wet conditions, seeds were subjected to 10% water activation (0.6 grams for 6 seeds tested) and allowed to equilibrate for 3 hours before sampling. The test was conducted over a 12 month period. Results are shown in the following table.

### Results: Headspace of Dry and Wet Seeds

The synergistic mixture of garlic/AITC is released at a relatively constant rate over 12 months.

| | | 1 month | 6 month | 12 month |
|---|---|---|---|---|
| | | Ng/l | Ng/l | Ng/l |
| 0.50% | Dry | 1448.2 | 1062.4 | 1059.2 |
| | Wet | 7369.2 | 11079.5 | 6094.9 |
| 1.00% | Dry | 1097.2 | 1517.7 | 1404.5 |
| | Wet | 8141.8 | 12022.2 | 13128 |

Upon water activation, there is a surge in the garlic/AITC concentration clearly indicating release of the actives.

To explore if seed germination was affected by the garlic/AITC system, 2×2 inch cotton swatches were placed into glass petri dishes. 3-4 ml of water was added to the cotton and 1 seed was placed on the swatch. The petri dish was placed into an oven set at 27° C. (78° F.) for observation of germination. A seed from each concentration level was observed. After 7 days elapsed time, all treated seeds showed clear evidence of germination.

The garlic/AITC capsules are stable on storage emanating garlic/AITC mixture over 12 months and also provide an increased level when the seeds are watered. No deleterious activity to the corn seed germination was observed.

### Example 4

### Example of a Solid Composition

Polyethylene Glycol 4000 was placed in a mixing vessel and the mixture of garlic oil and AITC was added with stirring. When homogenised, it was poured over a mixture of Zeolite and Bentonite clay in a cement mixer and tumbled until the mixture was a dry free flowing powder. The materials were mixed in the following proportion:

| | % (wt.) |
|---|---|
| Garlic/AITC (85:15) | 20 |
| Polyethylene Glycol 4000 (Union Carbide) | 1 |
| Bentonite H (Whitaker, Clark & Daniels) | 10 |
| Valfor ™ 100 Aluminosilicate Zeolite (PQ Corp.) | 69 |

The result was a free flowing powder.

### Example 5

Further examples of free-flowing powder (all amounts in % wt.):

| | | A | B | C | D |
|---|---|---|---|---|---|
| Active oils | Garlic | 8.5 | 12.75 | 8.5 | 17 |
| components | AITC | 1.5 | 2.25 | 1.5 | 3 |
| Fixative | Paraffin wax* | 1 | 1 | | |
| | Beeswax** | | | 1 | |
| | PEG 4000 | | | | 1 |
| Powder components | Ground corn cob | 60 | 55 | | |
| | Kaolinite*** | | | 49 | |
| | Bentonite | 29 | 29 | 40 | 19 |
| | Zeolite | | | | 60 |
| Total | | 100 | 100 | 100 | 100 |
| Free-flowing? Y/N | | Y | Y | Y | Y |

*Micropure ™ 185-CW microcrystalline wax (Shamrock Corp.)
**SP 422P (Strahl & Pitsch)
***(Southern Clay Products)

### Example 6

### Soil Testing of an Encapsulated Composition

Garlic oil, an 85/15 (wt/wt) garlic oil/AITC blend and water (control) were loaded into gelatin capsules available commercially from Givaudan Flavors Corp. The loading in each case was 20% (wt.)

The three capsule types were tested on samples of soil. The soil was derived from a cotton field (silt loam, pH 6.2, CEC (cation exchange capacity)<10 meq/100 g soil, organic matter<1.0%). It was naturally infested with root-knot nematode (Meloidogyne incognita), spiral nematode (Heliocotylenchus dihystera) and lesion nematode (Pratylenchus brachyurus). The soil was mixed 50/50 (vol.) and divided into 1 Kg lots, which were potted in PVC pots of 10 cm diameter.

To each of three sets of pots was added 100 ml of each of the three encapsulated compositions, giving a rate of 400 mg formulation per Kg soil. The pots were then covered with 1.5 mil (0.038 mm) thick clear polyethylene. After 8 days, the polyethylene was removed and the soils subjected to nematological analysis.

Each pot was then planted with “Hutcheson” soybean (5 seedlings per pot) and the plants were allowed to grow for 7 weeks. They were then removed from the soil and growth parameters were determined. In addition, soil samples were analysed to give a final nematode count and the roots were incubated to determine nematode levels in them. The results were as follows:

| | control | garlic | garlic/AITC |
|---|---|---|---|
| | Final nematode count | | |
| M. ingognita, pre-plant, number/ | 37 | 10 | — |
| 100 ml soil | | | |
| M. ingognita, final, number/100 ml soil | 53 | 25 | 10 |
| M. ingognita, number in root system | 500 | 310 | 200 |
| H. dihystera, number in root system | 15 | 39 | 2 |
| | other | | |
| Average shoot height (cm) | 25.2 | 26.5 | 24.7 |
| Average weight fresh roots (g) | 16.8 | 19.8 | 18.4 |

The results show that the overall performance of the garlic/AITC blend was significantly better than that of either the control or the garlic alone.

1. Pesticidal preparation comprising a pesticidal composition consisting essentially of a mixture of garlic oil and allyl isothiocyanates (AITCs) in the weight ratio of from 95:5 to 60:40, and optionally a carrier.

2. Preparation according to claim 1, in which the AITCs are provided by mustard oil.

3. Preparation according to claim 1 in which the proportion of garlic oil to AITCs is from 90:10 to 70:30.

4. Preparation according to claim 1 in which the proportion of garlic oil to AITCs is from 85:15 to 80:20.

5. Preparation according to claim 1, in which the composition is in solid form.

6. Preparation according to claim 5, in which the solid form is provided by the adsorption of the composition on to a porous solid carrier.

7. Preparation according to claim 5, in which the solid form is provided by the encapsulation of the composition.

8. Preparation according to claim 7, in which the capsules have hydrogel shells and oily cores.

9. Preparation according to claim 6, in which the composition adsorbed on to the porous solid carrier is premixed into a high molecular weight, low melting point wax or solid.

10. A method of controlling plant pests, comprising the application to the plant and/or to the soil in which it is growing a pesticidal preparation according to claim 1.

11. A method according to claim 10, in which the preparation is applied in solid form.

12. A method according to claim 11, in which the solid form is provided by the adsorption of the composition into a powdery porous solid carrier.

13. A method according to claim 12, in which the composition is premixed into a high molecular weight, low melting point wax or solid, prior to adsorption on to the solid.

14. A method according to claim 11, in which the solid form is provided by the encapsulation of the composition in capsules.

15. A method according to claim 14, in which the capsules have hydrogel shells and oily cores.

16. Pesticidal composition consisting essentially of a mixture of garlic oil and allyl isothiocyanates (AITCs) in the weight ratio of from 95:5 to 60:40.

17. A method of controlling plant pests, comprising the application to the plant and/or to the soil in which it is growing a pesticidal composition according to claim 16.

18. Pesticidal preparation comprising a pesticidal composition comprising a mixture of garlic oil and allyl isothiocyanates (AITCs) in the weight ratio of from 95:5 to 60:40, and optionally further comprising a carrier.

19. A method of controlling plant pests, comprising the application to the plant and/or to the soil in which it is growing a pesticidal composition according to claim 18.
